(19) United States
(12) Patent Application Publication
(10) Pub. No.: US 2006/0167836 A1
(43) Pub. Date: Jul. 27, 2006

(54) Method and structure for algorithmic overlap in parallel processing for exploitation when load imbalance is dynamic and predictable

(75) Inventors: Siddhartha Chatterjee, Yorktown Heights, NY (US); John A. Gunnels, Brewster, NY (US); Fred Gehrung Gustavson, Briarcliff Manor, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/039,907

(22) Filed: Jan. 24, 2005

(51) Int. Cl. G06F 7/00; G06F 17/30

(52) U.S. Cl. 707/2

(57) ABSTRACT

A method (and structure) of processing, on a computer having a plurality of processors, includes executing a set of tasks that includes a computational bottleneck in a repetitive procedure on a first subset of the plurality of processors. A set of non-bottleneck tasks of the repetitive procedure is executed on a second subset of the plurality of processors. In a steady-state processing of the repetitive procedure, the first subset of processors and the second subset of processors are together processing the repetitive procedure in a manner such that the first subset of processors and the second subset of processors are each operating substantially full-time.

### CROSS-REFERENCE TO RELATED APPLICATIONS

The following Application is related to the present Application:

U.S. patent application Ser. No. 10/______, filed on______, to Chatterjee et al., entitled “METHOD AND STRUCTURE FOR SKEWED BLOCK-CYCLIC DISTRIBUTION OF LOWER-DIMENSIONAL DATA ARRAYS IN HIGHER-DIMENSIONAL PROCESSOR GRIDS”, having IBM Docket YOR920040301US1.

### U.S. GOVERNMENT RIGHTS IN THE INVENTION

This invention was made with Government support under Contract No.: B517552, awarded by the Lawrence Livermore National Labs. The Government has certain rights in this invention.

### BACKGROUND OF THE INVENTION

1. Field of the Invention

The present invention generally relates to reducing the effect of computational bottlenecks in parallel processing algorithms that have predictable load imbalance. More specifically, overall computational speed and efficiency are improved by utilizing the predictability of the computational imbalance to define a ratio of bottleneck versus non-bottleneck processing so that the bottleneck computution moves along a computational front across the parallel processing units and processing units not currently engaged in the bottleneck computational steps perform non-bottleneck computations in a ratio that better utilizes their computational capacity.

2. Description of the Related Art

The present invention addresses a problem identified during development of the Assignee's BlueGene™ (BG/L) computer, but it is applicable in most, if not all, parallel processing environments for algorithms that have a predictable load imbalance.

The specific problem being addressed herein is the performance bottleneck (e.g., a critical path) in parallel processing algorithms with predictable (either shifting or static) load imblance. The known solutions to this problem include tuning the code involved in the bottleneck, dynamic load (re-)balancing, overlapping computation, and communication.

However, these known solutions have drawbacks. For example, code tuning is labor intensive and, in the area of high performance computing, draws on a fairly limited number of experts. General purpose load balancing is typically complicated to code and to debug, consumes time in the redistribution phase, and seems unnecessary in the environment under consideration (e.g., predictable load imbalance, either shifting or static). Also, overlapping schemes often have the drawback of disrupting the communication fabric of a machine in that they disallow some communication schemes that have peak bandwidth/latency characteristics.

Thus, a need continues to exist to reduce the effect of a computational bottleneck in parallel processing algorithms for which there is inherently a predictable load imbalance, even if the bottleneck itself cannot be eliminated.

### SUMMARY OF THE INVENTION

In view of the foregoing, and other, exemplary problems, drawbacks, and disadvantages of the conventional system, it is a an exemplary feature of the present invention to provide a general technique of improving computational efficiency for processing, on a parallel computer, repetitive procedures that include a bottleneck and a predictable imbalance.

It is another exemplary feature of the present invention to provide a technique in which processing repetitive procedures that include a bottleneck and a predictable imbalance on a parallel computer can be improved by reducing the overall computational time and improving overall computational efficiency by performing the procedure to more fully utilize the computational capabilities of processors in a parallel processing environment by having each processor working on the procedure rather than remaining idle until a bottleneck computation has been completed.

To achieve the above exemplary features and others, in a first exemplary aspect of the present invention, described herein is a method (and structure) of processing, on a computer having a plurality of processors, a method including executing a set of tasks that comprise a computational bottleneck in a repetitive procedure on a first subset of the plurality of the processors, and executing a set of non-bottleneck tasks of the repetitive procedure on a second subset of the plurality of processors, wherein, in a steady-state processing of the repetitive procedure, the first subset of processors and the second subset of processors are together processing the repetitive procedure in a manner such that the first subset of processors and the second subset of processors are each operating substantially full-time.

In a second exemplary aspect of the present invention, described herein is a computer network, including at least one of: a first computer connected to the network, the first computer comprising a plurality of processing units divided into a first subset executing a set of tasks that comprise a computational bottleneck in a repetitive procedure and a second subset executing a set of non-bottleneck tasks of the repetitive procedure, wherein, in a steady-state processing of the repetitive procedure, the first subset of processors and the second subset of processors are together processing the repetitive procedure in a manner such that the first subset of processors and the second subset of processors are each operating substantially full-time; and a second computer connected to the network, the second computer serving as a server storing a set of computer program instructions for a repetitive procedure that can be downloaded by the first computer and executed thereon in the manner described.

In a third exemplary aspect of the present invention, described herein is a signal-bearing medium tangibly embodying a program of machine-readable instructions executable by a digital processing apparatus to perform the above-described method of processing on a computer having a plurality of processors.

The technique of the present invention provides improved performance in parallel processing algorithms and has been a significant contribution allowing the BG/L computer to acquire its current status as being the fastest computer in the world.

While the present invention was discovered in the context of the development of the BG/L computer and linear algebra processing, it is applicable to a wider computing environment and a wider area of potential uses, exemplarily ranging from areas as diverse as computations for manufacturing systems to scheduling complicated events such as activities in trucking fleets.

Indeed, any process that can be modeled such that it can be executed on a parallel processing computer system in a manner in which a computational bottleneck exists in a predictably repetitive manner can potentially benefit from the present invention.

### BRIEF DESCRIPTION OF THE DRAWINGS

The foregoing and other exemplary features, aspects and advantages will be better understood from the following detailed description of an exemplary embodiment of the invention with reference to the drawings, in which:

FIG. 1 shows a global view 100 of a parallel program in process of execution performing, exemplarily, the linear algebra LU Factorization subroutine;

FIG. 2 shows a snapshot in time of the processor view 200 of the step shown in FIG. 1;

FIG. 3 shows a breakdown of jobs 300 for the processor view shown in FIG. 2 in accordance with the present invention;

FIG. 4 shows the breakdown 400 of processing jobs for the processor view as the computational front has moved forward in time relative to the snapshot view in FIG. 3;

FIG. 5 shows the breakdown of jobs 500 for the processor view as the computational front has moved forward in time relative to the snapshot view in FIG. 4;

FIG. 6 shows an exemplary flowchart 600 of the generalized concepts of the present invention, as exemplarily explained in FIGS. 1-5;

FIG. 7 illustrates an exemplary generic block diagram 700 of a software module into which concepts of the present invention have been incorporated;

FIG. 8 illustrates an exemplary hardware/information handling system 800 for incorporating the present invention therein; and

FIG. 9 illustrates a signal bearing medium 900 (e.g., storage medium) for storing steps of a program of a method according to the present invention.

### DETAILED DESCRIPTION OF AN EXEMPLARY EMBODIMENT OF THE INVENTION

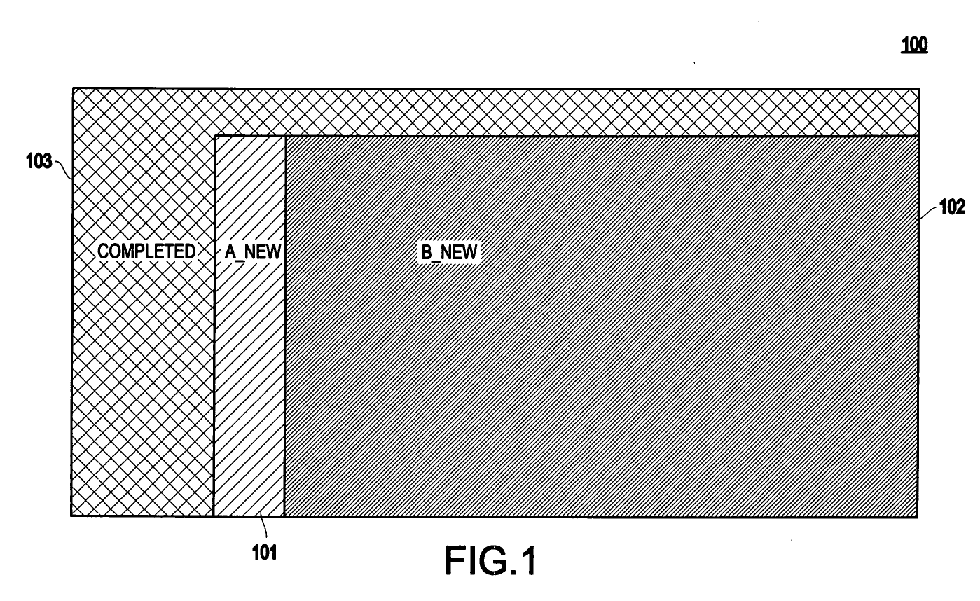

Referring now to the drawings, and more particularly to FIGS. 1-9, an exemplary embodiment of the present invention will now be described.

The present invention was an integral part of the development program of the BG/L computer specifically in the context of linear algebra processing. However, it is noted that there is no intention to confine the present invention to either the BG/L environment or to the environment of processing linear algebra subroutines. It is understood that one of ordinary skill in the art, after having read the details described herein, would readily be able to apply the present invention as applicable to any number of parallel processing algorithms and applications.

Before proceding with details of the present invention, the following general discussion provides a background of linear algebra subroutines and computer architecture, as related to the terminology used herein, for a better understanding of the present invention.

Linear Algebra Subroutines

The explanation of the present invention includes reference to the computing standard called LAPACK (Linear Algebra PACKage) and to various subroutines contained therein. Information on LAPACK is readily available on the Internet.

For purpose of discussion only, Level 2 and Level 3 BLAS (Basic Linear Algebra Subprograms) of the LAPACK (Linear Algebra PACKage) are mentioned, but it is intended to be understood that the concepts discussed herein are easily extended to other linear algebra mathematical standards and math library modules and, indeed, is not even confined to the linear processing environment.

When LAPACK is executed, the Basic Linear Algebra Subprograms (BLAS), unique for each computer architecture and provided by the computer vendor, are invoked. LAPACK comprises a number of factorization algorithms for linear algebra processing.

For example, Dense Linear Algebra Factorization Algorithms (DLAFAs) include matrix multiply subroutine calls, such as Double-precision Generalized Matrix Multiply (DGEMM). At the core of Level 3 Basic Linear Algebra Subprograms (BLAS) are “L1 kernel” routines, which are constructed to operate at near the peak rate of the machine when all data operands are streamed through or reside in the L1 cache.

The most heavily used type of Level 3 L1 DGEMM kernel is Double-precision A Transpose multiplied by B (DATB), that is, C=C−A^{T} *B, where A, B, and C are generic matrices or submatrices, and the symbology A^{T} means the transpose of matrix A.

As is well known in the art, the processing for linear algebra subroutines involves a repetitive calculation for each member of an array of data. This repetitive processing will often have an identifiable processing bottleneck in which a relatively time-consuming step is required to generate data for a later processing step. One such example is the linear algebra factorization routines.

Returning now more specifically to the present invention, one of the exemplary key concepts is that of taking an algorithm with some large macro step or steps into multiple parametric substeps and to reorder the execution of those substeps so as to allow computation of a “bottleneck” to coincide (e.g., in time) with one or more new substeps.

More simply stated, in a process in which substeps are executed sequentially, new substeps are constantly arising, and one or more of the substeps takes more time to execute, thereby causing a bottleneck, the method of the present invention teaches to allow some set(s) of processors to work on the bottleneck while others work on the new substeps. Since the bottleneck can be made to move in a predictable way across the entire processing set, timing can be constructed such that the overlap dynamically shifts across the processor set, keeping all processors busy all (or almost all) of the time.

For example, an algorithm of the following form is considered. There is some (relatively) slow component A and a relatively fast (high-performance) component B. Further, it is assumed that the bulk of the overall work is in the B component. This characteristic makes A a true bottleneck.

Although it is premature in the discussion to describe totally what is shown in FIG. 1, this concept can be seen in this figure. FIG. 1 shows a global view 100 of a parallel program in process of execution performing the linear algebra operation LU Factorization. The slow component of the processing is shown as the portion labeled “A_new” 101. The bulk of the processing is “B_new” 102. The portion that is completed 103 is shown on the left.

Finally, to disallow trivial solutions to the problem, it is assumed that the B work of some “round” of computation is dependent upon the A work of the same round and that there is a round-to-round dependency (e.g., later rounds are dependent upon earlier rounds, so as not to be trivially parallelizable between rounds).

If A is a component whose load gets spread out (relatively) uniformly across the processor grid (when viewed over the course of the entire computation), the following general scheme should allow us to keep all of the nodes busy at all times, moving the bottleneck around as quickly as possible. In the context of the present invention, the term “node” refers to one of the processors in the processor grid comprising a parallel processor machine.

The “steady state” of an exemplary algorithm that implements the present invention is described below. The bootstrapping process computes the bottleneck for one “round” and leaves the other nodes idle (worst case).

While it is true that the bottleneck remains relatively untouched, the overall performance of the algorithm may be greatly improved. Moreover, it is noted that removing bottlenecks tends to be an issue of algorithmic restructuring, not an automated process by any means.

On the subset of nodes that computes A in a current round (e.g., Set(A_x)), compute A, where A takes S units of time to compute. Consider the subset of nodes that are not computing A this round, which is symbolized in this discussion as “˜Set(A_x)”. ˜Set(A_x) has two subsets ˜Set(A_x)′ and ˜Set(A_x)″. ˜Set(A_x)′ are nodes that are caught up with the computational (related to B work) debt that they incurred computing A in some previous round and ˜Set(A_x)″ are those who have not yet worked off their debt from previous rounds:

Some nodes in ˜Set(A_x)′ simply compute B at this time, where, without loss of generality, it can be assumed that B will cost roughly the same on all processors, say R units, where units is some quanta of time that maps to the sub-tasks mentioned above. The nodes in ˜Set(A_x)′ that will compute A in the next round compute (R-S) of this “B” work.

Some nodes in ˜Set(A_x)″ catch up with some of their debt from the previous round (say Q units of debt) and compute R-Q units of the (new) B work, where R is the total amount of B work that these processors are to do for this round.

As described herein, an exemplary key idea of the present invention is to use something simpler and more efficient than, priority queues for the two (or more) work pools. If there were two priority queues, in the scenario described above, nodes would compute B work until any A work came their way.

However, the problems with this approach are numerous:

1) There is no way to plan the B computations and, in many scientific codes, far greater efficiencies can be gained by doing as much work as can be done at the current time. Breaking a task, X, that can be done in one computation into tasks X1 and X2, with a poll “is there any A work to do” in between will cost performance unless: a) the answer is “yes” and b) X1 takes Y units to execute and using an X1′ of size (Y−a), for some amount a, would result in the answer being “no”;

2) There are overheads associated with managing the work pools; and

3) Polling the work pools is costly and inefficient.

In contrast, the approach of the present invention is to create a plan regarding how much of the B work should be engaged in before switching over to A work (that is, by the nature of the plan, expected to be available). Simple performance models of the A work and the B work allow dynamic adjustment of the switchover rate on each node.

That is, nodes can simply queue up B work and perform those tasks in-between rounds of A work. As long as the amount of A work is spread (relatively) evenly, even if irregularly, around the nodes, this approach will work, although it may require a good deal of storage for the operands involved in the B operation. The exemplary target applications of the present invention, primarily dense linear algebra factorizations, have an additional characteristic which makes all of this open-ended operand “stacking” unnecessary.

An exemplary technique for spreading work uniformly in an organized pattern in the nodes, such as a column, is demonstrated in the above-referenced co-pending Application, the contents of which are incorporated by reference.

In view of the above-referenced co-pending Application, the contents of which are incorporated herein by reference, in several of the most widely used linear algebra factorization routines (e.g., LU, Cholesky, etc.), it is relatively straightforward to construct a parallel processing implementation such that the critical path (A) is confined to a “logical” column of processors.

Furthermore, the B work that corresponds to (e.g., is dependent upon) the x^{th} A task, Bₓ, is greater than or equal to the B work for the Bₓ₊₁, task and less than that for the Bₓ₋₁ task. Finally, the compute units “in front of” the computational front (the nodes where the A task “will be”) have more work to do (given a standard block-cyclic data distribution that is the only widely supported library standard for such codes) than the nodes behind the front (for a given round, x). The combination of these facts leads to a simple algorithmic change such that:

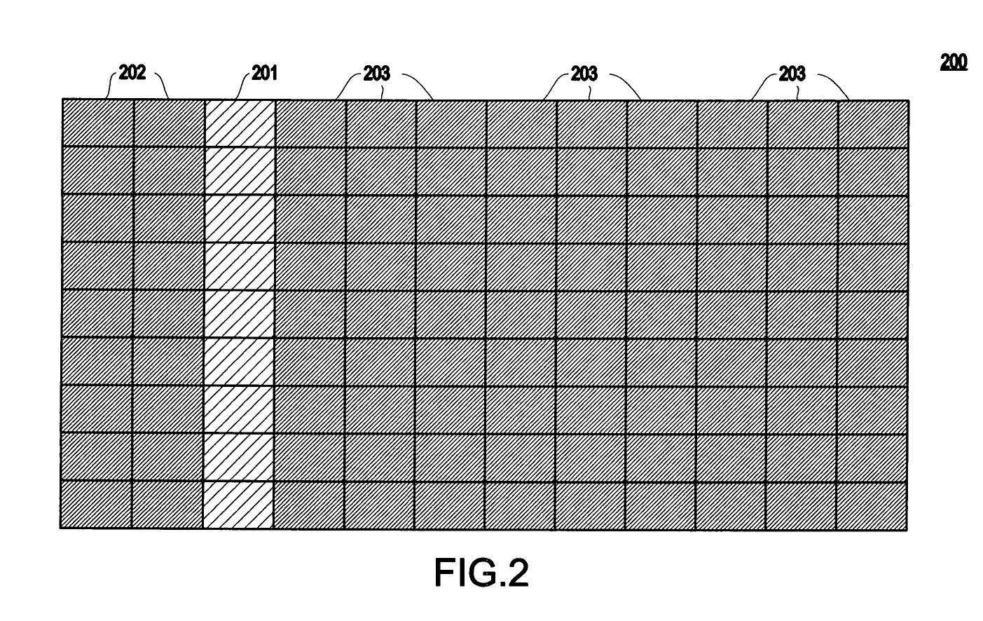

a) Nodes in the front compute A work, broadcast the result, and compute “some of” (to be demonstrated in FIGS. 2-5) their current B work;

b) Nodes caught up on their lagging B work, compute B for the current round (typically all of their B work);

c) Nodes not caught up on B work from rounds less than x, catch up on that work and compute some of the work for the current round (the amount is determined by the most heavily loaded processor. If they catch up, they become (b) nodes.

It is noted that, although the algorithm is described at a column-by-column level, refinement to blocks or even partial blocks is both straightforward and useful. However, such a description might occlude the concepts being demonstrated in this discussion.

FIGS. 1-5 show visually the concept discussed above for the exemplary processing of the LU linear algebra subroutine.

FIG. 1 represents a global view 100 of a parallel program in process of execution performing the linear algebra subroutine LU Factorization on a matrix. Crosshatched portion 101 represents the portion of the matrix that has already been factored by the LU Factorization subroutine.

Diagonal-lined portion 102 represents the portion of the matrix that is being processed by the panel factorization operation of the LU Facturization subroutine and corresponds to the “A” (e.g., slow) work discussed above.

Unlined portion 103 represents the portion of the matrix currently being processed by the DGEMM update in the LU factorization subroutine. This DGEMM update portion corresponds to the “B” work (e.g., efficient, but plentiful) discussed above.

FIG. 1 is assumed as showing the work for the current iteration (e.g., the “current A work”).

FIG. 2 shows the snapshot in time of the processor view 200 of the current iteration shown in FIG. 1, in accordance with the technique of the present invention. That is, this figure shows a representation of the logical layout of the parallel processors currently engaged in the LU factorization operation.

It is first noted that no processors are shown as crosshatched, since all processors are still involved in some part of processing the algorithm. As the algorithm is completed, a wave of crosshatching would begin on the left and move toward the right, a point in the processing not yet reached in FIG. 2.

Diagonal-lined portion 201 shows the processors currently engaged in the panel factorization steps of the LU Factorization subroutine (e.g., the slow “A” work). Unlined portions 202,203 represent processors currently executing the DGEMM update in the LU Factorization subroutine (e.g., the efficient, but plentiful “B” work).

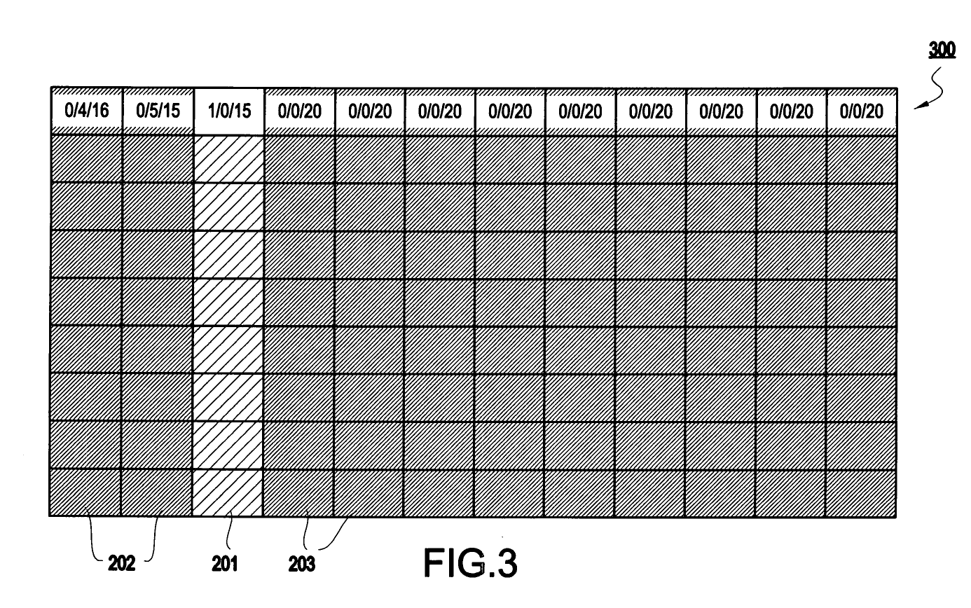

FIG. 3 exemplarily shows a breakdown of jobs 300 for the processor view shown in FIG. 2, as reflecting one possible pattern of organizing the work for the LU Factorization subroutine. The three numbers X/Y/Z in each node respectively represents the following:

X is the number of A jobs to do (it is exemplarily assumed that there are five units of time per A). It should be noted that only the crosshatched portion 201 is working on the A job and that this A work is assumed as being done by a column of processors;

Y is the number of B jobs to do from the previous round (“catch up”). It is exemplarily assumed that there is 1 unit of time per B. It should be noted that only those processors in portion 202 are currently engaged in this category of B work; and

Z is the number of B jobs to do from this iteration. This number depends on the current A job completing. It can be seen that the portion 203 of processors to the right of those processors 201 are all currently executing the “new” B work. However, as taught by the present invention, the portion 202 to the left of the A work portion 201 is also engaged in “B” work.

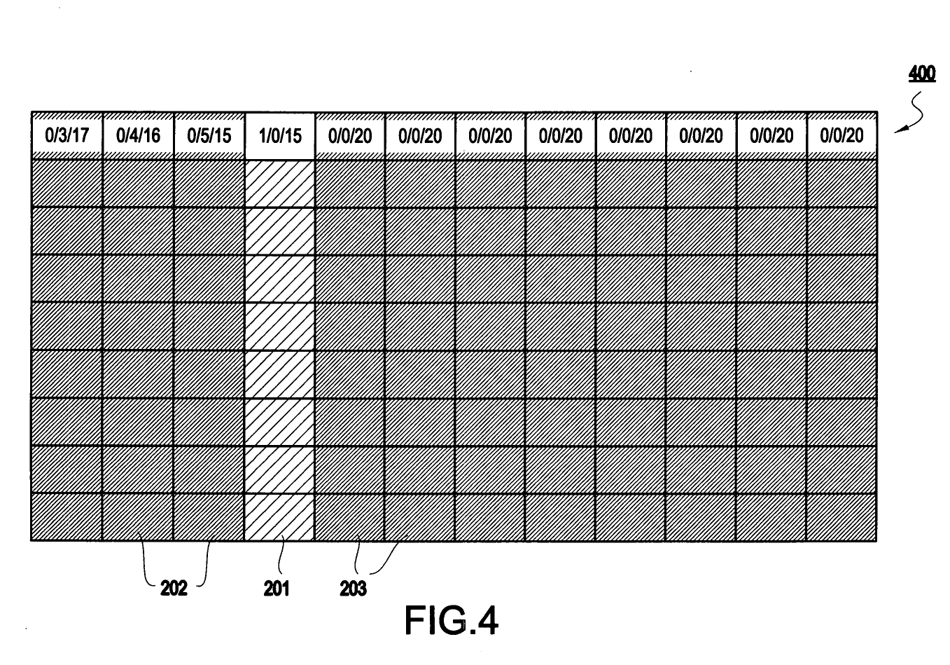

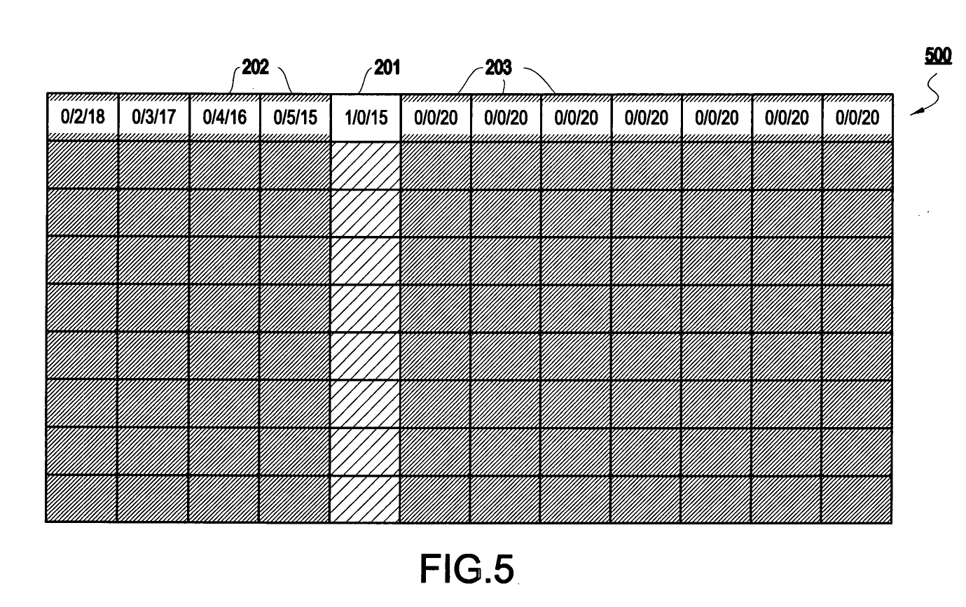

FIG. 4 shows the breakdown of jobs 400 for the processor view as the computational front moves forward one step in time (e.g., from “1/0/15” in FIG. 3 to “1/0/15” in FIG. 4), and FIG. 5 shows the similar movement forward in another step forward in time.

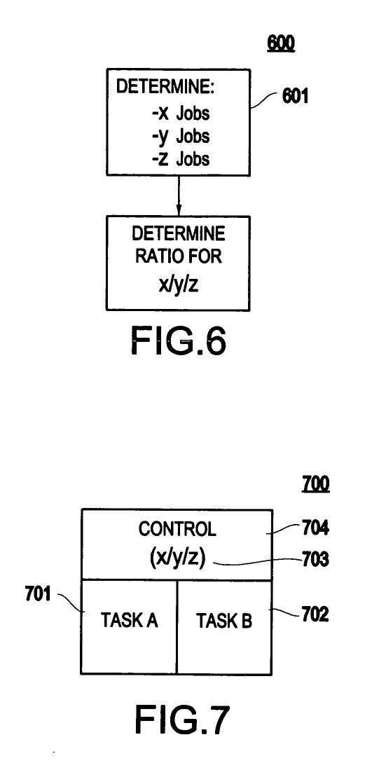

FIG. 6 shows an exemplary flowchart 600 of the generalized concepts of the present invention exemplarily illustrated in FIGS. 1-5 as having been incorporated into the LU subroutine.

First, as explained earlier, it is assumed that a number of parallel processing nodes are involved in processing an operation having a slow work “A”, also referred to as the “bottleneck task”, and an efficient, but plentiful work “B”. It is further assumed that the processing nodes can be organized so that specific nodes can predictably concurrently compute a specific aspect of the processing operation at any one point in time (e.g., operate as a processing “front”), such as the A work.

In step 601, the jobs associated with the processing are broken down into three categories, as follows: X being the number of A jobs to do; Y being the number of B jobs to do from the previous round (“catch up”); and Z being the number of B jobs to do from the present iteration.

In step 602, by analyzing the nature of the tasks involved, including a relative number of steps, a ratio is determined so that, at any specific interval in time, each processor is successively controlled, in accordance with the manner in which the processing front progresses, to perform these three categories X,Y,Z of work in accordance a predetermined plan regarding how much of the B work will be engaged in before switching over to A work.

This ratio provides the following generalized effects:

a) Nodes in the computation front compute A work, broadcast the result, if and as appropriate for the processing being executed, and compute a specified amount of their current B work;

b) Nodes caught up on their lagging B work, compute B for the current round (typically all of their B work);

c) Nodes not caught up on B work from rounds less than x, catch up on that work and compute some of the work for the current round (the amount is determined by the most heavily loaded processor. If they are caught up, they become (b) nodes.

It will be readily apparent to one of ordinary skill in the art, after taking this discussion as a whole, that the specific ratios to optimize performance can be readily determined by analyzing the underlying repetitive process. That is, each process will have an optimum ratio of current/left-over work in the non-bottleneck steps that can be spread over processor units not currently engaged in the bottleneck steps.

By analyzing the underlying repetitive computation process and pre-assigning this optimum ratio of current/left-over non-bottleneck steps and further incorporating this non-bottleneck ratio of tasks into a ratio that includes the bottleneck steps, all processor units can be kept busy at all times (or, at least, substantially all times), executing steps in either the bottleneck portion or in the non-bottleneck portion of the repetitive computation process.

FIG. 7 shows an exemplary generic block diagram 700 of the software module intended to execute a repetitive computation process in a parallel processing environment, as having been modified to incorporate concepts of the present invention. Consistent with the exemplary discussion above, his software module might be, for example, the linear algebra LU factorization subroutine.

Also consistent with the discussion above, the subroutine includes a bottleneck task A 701 and at least one non-bottleneck task B 702. Also consistent with the above discussion, in accordance with the present invention, the non-bottleneck task or tasks 702 have been further broken down into sub-tasks and a ratio 703 has been predetermined and incorporated into the software module 700 such that parallel processing units will be kept busy doing either bottleneck processing or non-bottleneck processing.

Although the example in FIG. 6 shows the ratio 703 as having been incorporated into software module 700 exemplarily in the context of a control submodule 704, it should be apparent to one of ordinary skill in the art that the ratio could actually be incorporated into the processing module by simply building the ratio into the computational steps that execute the subroutine.

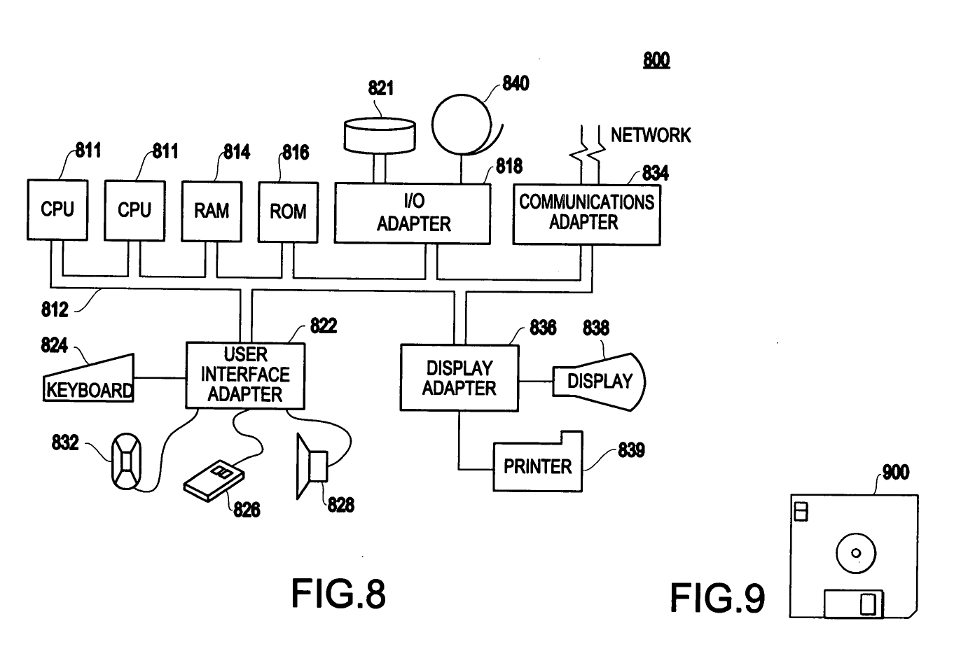

FIG. 8 illustrates a typical hardware configuration of an information handling/computer system in accordance with the invention and which preferably has at least one processor or central processing unit (CPU) 811.

The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

The second exemplary aspect of the present invention additionally raises the issue of general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

In a variation, the present invention could be implemented by modifying standard matrix processing modules, such as described by LAPACK, so as to be based on the principles of the present invention. Along these lines, each manufacturer could customize their BLAS subroutines in accordance with these principles.

It should also be recognized that other variations are possible, such as versions in which a higher level software module interfaces with existing linear algebra processing modules, such as a BLAS or other LAPACK or ScaLAPACK module, to incorporate the principles of the present invention.

Moreover, the principles and methods of the present invention could be embodied as a computerized tool stored on a memory device, such as independent diskette 900, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module to interact with existing linear algebra processing modules. It should also be obvious to one of skill in the art that the instructions for the technique described herein can be downloaded through a network interface from a remote storage facility.

All of these various embodiments are intended as included in the present invention, including the aspect that the present invention should be appropriately viewed as a method to enhance the computation of repetitive computation processes that have at least one bottleneck and a predictable imbalance. The present invention is not intended as being confined to linear algebra subroutines or even to applications in which linear algebra subroutines are therein incorporated, since it is readily recognizable that the concepts of the present invention are easily adapted to a larger scale processing than the lower-level linear algebra subroutine level exemplarily discussed herein.

In yet another exemplary aspect of the present invention, it should also be apparent to one of skill in the art that the principles of the present invention can be used in yet another environment in which parties indirectly take advantage of the present invention.

For example, it is understood that an end user desiring a solution of a scientific or engineering problem may undertake to directly use a computerized linear algebra processing method that incorporates the method of the present invention. Alternatively, the end user might desire that a second party provide the end user the desired solution to the problem by providing the results of a computerized linear algebra processing method that incorporates the method of the present invention. These results might be provided to the end user by a network transmission or even a hard copy printout of the results.

The present invention is intended to cover all of these various methods of implementing and of using the present invention, including that of the end user who indirectly utilizes the present invention by receiving the results of matrix processing done in accordance with the principles herein.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of processing, on a computer having a plurality of processors, said method comprising:
executing a set of tasks that comprises a computational bottleneck in a repetitive procedure on a first subset of said plurality of said processors; and
executing a set of non-bottleneck tasks of said repetitive procedure on a second subset of said plurality of processors,
wherein, in a steady-state processing of said repetitive procedure, said first subset of processors and said second subset of processors are together processing said repetitive procedure in a manner such that said first subset of processors and said second subset of processors are each operating substantially full-time.

2. The method of claim 1, wherein said first subset of processors results in a computational front executing said bottleneck and
wherein said first subset of processors sequentially shifts to a new first subset of said plurality of processors after a repetitive time interval and said second subset of processors correspondingly shifts to a new second subset of processors after said repetitive time interval.

3. The method of claim 2, wherein said plurality of processors are organized as a multi-dimensional array of processors and said computational front shifts across said multi-dimensional array of processors in a pattern.

4. The method of claim 3, wherein said pattern comprises a line of processors in said multi-dimensional array.

5. The method of claim 3, wherein said repetitive procedure comprises a linear algebra subroutine.

6. The method of claim 1, wherein said set of non-bottleneck tasks is divided into a plurality of portions of non-bottleneck tasks.

7. The method of claim 6, wherein said plurality of portions of non-bottleneck tasks comprises a first portion and a second portion,
said first portion comprising non-bottleneck tasks that are new tasks to be executed prior to executing said bottleneck tasks, said second portion comprising non-bottleneck tasks that are incurred from executing said bottleneck tasks.

8. The method of claim 7, wherein said bottleneck tasks, said first portion of bottleneck tasks, and said second portion of bottleneck tasks are organized to comprise a ratio of work to be sucessively assigned to processing units such that said first subset of processors and said second subset of processors are each operating substantially full-time.

9. The method of claim 8, wherein said first subset of processors results in a computational front executing said bottleneck and said first subset of processors sequentially shifts to a new first subset of said plurality of processors after a repetitive time interval and said second subset of processors correspondingly shifts to a new second subset of processors after said repetitive time interval.

10. The method of claim 9, wherein said plurality of processors is considered as being organized as a multi-dimensional array of processors and said computational front shifts across said multi-dimensional array of processors in a pattern.

11. The method of claim 10, wherein said pattern comprises a line of processors in said multi-dimensional array.

12. The method of claim 1, wherein said repetitive procedure comprises a linear algebra subroutine.

13. A computer, comprising:
a plurality of processing units, said plurality including:
a first subset executing a set of tasks that comprises a computational bottleneck in a repetitive procedure; and
a second subset executing a set of non-bottleneck tasks of said repetitive procedure,
wherein, in a steady-state processing of said repetitive procedure, said first subset of processors and said second subset of processors are together processing said repetitive procedure in a manner such that said first subset of processors and said second subset of processors are each operating substantially full-time.

14. The-computer of claim 13, wherein said repetitive procedure comprises a linear algebra subroutine.

15. A computer network, comprising at least one of:
a first computer connected to said network, said first computer comprising a plurality of processing units, said plurality of processing units divided into:
a first subset executing a set of tasks that comprises a computational bottleneck in a repetitive procedure; and
a second subset executing a set of non-bottleneck tasks of said repetitive procedure,
wherein, in a steady-state processing of said repetitive procedure, said first subset of processors and said second subset of processors are together processing said repetitive procedure in a manner such that said first subset of processors and said second subset of processors are each operating substantially full-time; and
a second computer connected to said network, said second computer serving as a server storing a set of computer program instructions for a repetitive procedure that can be downloaded by said first computer and executed thereon.

16. A signal-bearing medium tangibly embodying a program of machine-readable instructions executable by a digital processing apparatus to perform a method of processing on a computer having a plurality of processors, said method comprising:
executing a set of tasks that comprises a computational bottleneck in a repetitive procedure on a first subset of said plurality of said processors; and
executing a set of non-bottleneck tasks of said repetitive procedure on a second subset of said plurality of processors,
wherein, in a steady-state processing of said repetitive procedure, said first subset of processors and said second subset of processors are together processing said repetitive procedure in a manner such that said first subset of processors and said second subset of processors are each operating substantially full-time.

17. The signal-bearing medium of claim 16, wherein said signal-bearing medium comprises a diskette intended to be inserted into a drive unit of said computer.

18. The signal-bearing medium of claim 16, wherein said signal-bearing medium comprises a computer memory in first computer connected to a network and said program of machine-readable instructions is available to be downloaded to a second computer in said network.

19. The signal-bearing medium of claim 16, wherein said signal-bearing medium comprises a computer memory in first computer connected to a network, said program of machine-readable instructions being executed on said first computer after having been downloaded from a second computer in said network.

20. The signal-bearing medium of claim 16, wherein said repetitive procedure comprises a linear algebra subroutine.

21. A system comprising:
means for executing a set of tasks that comprises a computational bottleneck in a repetitive procedure on a first subset of said plurality of said processors; and
means for executing a set of non-bottleneck tasks of said repetitive procedure on a second subset of said plurality of processors,
wherein, in a steady-state processing of said repetitive procedure, said first subset of processors and said second subset of processors are together processing said repetitive procedure in a manner such that said first subset of processors and said second subset of processors are each operating substantially full-time.
